(19) United States
(12) Patent Application Publication
(10) Pub. No.: US 2005/0250014 A1
(43) Pub. Date: Nov. 10, 2005

(54) Energy storage devices and energy storage device modules

(76) Inventors: Yoshiaki Kumashiro, Mito (JP); Juichi Arai, Higashiibaraki (JP); Mituru Kobayasi, Hitachiota (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/060,478

(22) Filed: Feb. 18, 2005

(30) Foreign Application Priority Data
May 6, 2004 (JP) 2004-136973

(51) Int. Cl. H01M 6/14

(52) U.S. Cl. 429/303; 429/322

(57) ABSTRACT

An energy storage device comprising a positive active material layer having a positive active material capable of inserting and releasing lithium ions, a positive electrode plate having a layer capable of effecting non-faradic like reaction upon physical adsorption and desorption of the ions to accumulate and discharge charges, and a negative plate having a negative active material layer made of carbonaceous material that is capable of absorbing and releasing mainly lithium in the ionized state in a collector, and an insulator layer for electrically insulating the positive electrode plate from the negative electrode plate that causes only mobile ions permeate.

### CLAIM OF PRIORITY

This application claims priority from Japanese patent application serial No. 2004-136973, filed on May 6, 2004, the content of which is hereby incorporated by reference into this application.

### FIELD OF THE INVENTION

The present invention relates to energy storage devices and energy storage device modules for storing and discharging electric energy.

### RELATED ART

In recent years, electric power sources with higher input and output than the conventional ones have been desired for electric cars, hybrid cars, electric tools, etc. Power sources of higher power capacity, which are capable of quicker charging and discharging than lithium secondary batteries, etc. that have been used for the above applications are also desired.

Particularly, the power sources should be less dependable on a state of charge and discharge of batteries and less dependable on temperatures so that the power sources can keep desired input and output characteristics even at temperatures below the freezing temperature.

For the above demands, there are disclosed in the following patent documents No. 1 to No. 3 lithium secondary batteries wherein activated charcoal is mixed as an electric double layer capacitor with positive electrode active materials of the lithium secondary batteries.

Lithium secondary batteries having no activated charcoal as a material for the electric double layer capacitor have poor charge-discharge characteristics in a large current region; particularly, they exhibit extremely poor input-output characteristics at low temperatures. Further, the electric double layer capacitor alone has a low energy density and hence does not meet requirements for batteries, i.e. a small size and long service life batteries. Further, if the activated charcoal as the electric double layer capacitor material is mixed with the positive electrode active material in the lithium secondary battery, it is difficult to increase an amount of the activated charcoal so that the absolute value of the capacitance is small and output characteristics at low temperatures are insufficient.

Patent document No. 1: Japanese Patent Laid-open No. 2001-110418

Patent document No. 2: Japanese Patent Laid-open No. 2002-260634

Patent document No. 3: Japanese Patent Laid-open No. 2003-92105

### SUMMARY OF THE INVENTION

It is an object of the present invention to provide an energy storage device and an energy storage device module that solve the above-mentioned problems.

The energy storage device of the present invention comprises a positive electrode active material layer having a positive electrode active material capable of inserting and releasing lithium ions to accumulate and release charges, a positive electrode plate having a layer where a non-faradic like reaction takes place upon the ions are adsorbed and desorbed therein, a negative electrode plate having a negative active material of carbonaceous material capable of absorbing or occluding therein and releasing mainly lithium in the ionized state, and an insulating layer that causes only mobile ions penetrate for electrically insulating the positive electrode plate from the negative electrode plate.

In the above, the “faradic reaction or faradic like reaction” means a reaction of transfer of electric charges through an electric double layer and through the surface of the electrode into the active material upon change of oxidation state of the active material.

On the other hand, the “layer where a non-faradic like reaction takes place” means “a layer wherein a transfer of electric charges passing through boundaries of the electrodes does not take place, but the electric charges are accumulated and released upon physically adsorbing and desorbing ions in the surface of the electrodes”. This is a reaction similar to that of the electric double layer capacitor.

The energy storage device of the present invention exhibits particularly excellent output characteristics at low temperatures.

### BRIEF DESCRIPTION OF THE DRAWINGS

FIG. 1 is a graph showing discharge curves of a positive electrode plate of an energy storage device according to an embodiment of the present invention and an energy storage device according to a comparison example.

FIG. 2 shows curves of a positive electrode potential, negative electrode potential and discharge termination voltage.

FIG. 3 is a cross sectional view of a coin type energy storage device according to an embodiment of the present invention.

FIG. 4 is a cross sectional view of a coin type energy storage device according to another embodiment of the present invention.

FIG. 5 shows a cross sectional view of a lithium secondary battery for a comparison with the energy storage device of the present invention.

FIG. 6 is a graph showing I-V characteristics used for calculation of output performance.

FIG. 7 is a graph showing relationship between DOD (Depth of Discharge) and output density at 25° C. of the energy storage device of the present invention and a lithium secondary battery for comparison.

FIG. 8 is a partially broken, perspective view of the energy storage device module according to an embodiment of the present invention.

FIG. 9 is a diagrammatic view of a construction of the hybrid car according to an embodiment of the present invention.

### DETAILED DESCRIPTION OF THE PREFERRED EMBODIMENTS

The present invention will be explained by reference to drawings for the purpose of illustration, but the scope of the present invention will not be limited by these embodiments.

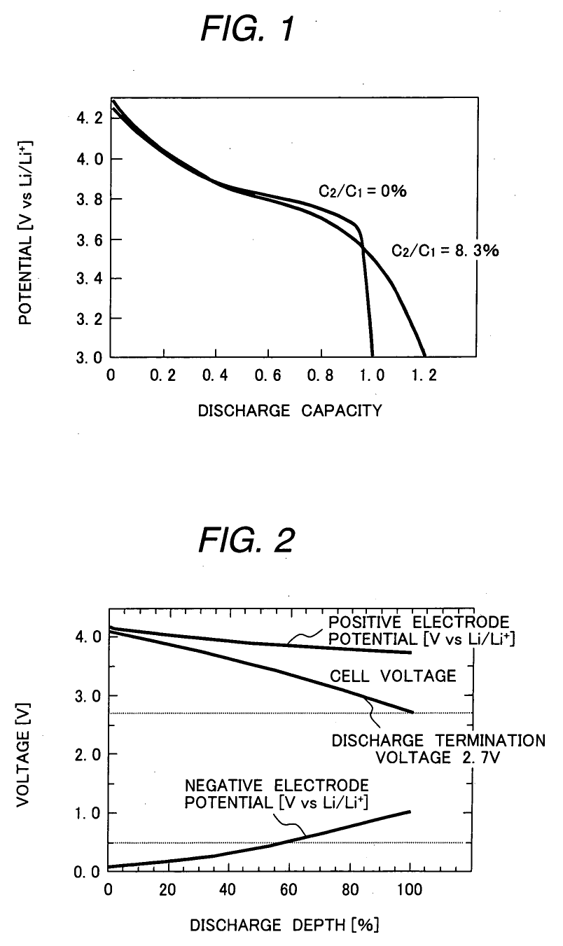

In FIG. 1, there is shown an example of a discharge curve over the range of from 3.0 to 4.3 V when a first positive electrode (C₁/C₂=0%) of a lithium secondary battery and a second positive electrode (C₁/C₂=8.3%), which has a layer of activated charcoal as an electric double layer capacitor on a positive electrode active material, were used. A reference electrode used in combination with the electrodes is lithium metal. When a capacitance rate (C₂/C₁) of the positive activated material to the activated charcoal is 5% or more, a discharge capacity at 3.6 V or higher becomes larger. When the rate is 0.2% or less, it is possible to avoid an increase in an electrode resistance of the activated charcoal. In the above description, C₁ is a discharge capacity of the positive active material measured in a range of from 3.0 to 4.4 V with respect to a Li/Li⁺potential; C₂ is a discharge capacity of the activated charcoal contained in the positive active material measured in the range of from 3.0 to 4.3 V with respect to the Li/Li⁺ potential.

FIG. 2 shows a discharge curve at a range of from 2.7 to 4.2 V of a lithium secondary battery and potentials at positive and negative electrodes where lithium metal is used as a reference electrode. As is shown in Fug. 2, a change of the potential at the end period of discharge (right side of the graph) is large, and when the cell potential arrives at the final discharge potential (about 2.7 V), the positive electrode is discharged until 3.7 V. A discharge depth means a value when a discharge capacity is 100% over the range of from 4.2 to 2.7 V.

Accordingly, in order to secure effects of a positive electrode where the activated charcoal layer is formed on the positive active material of the lithium secondary battery as the electric double layer capacitor, it was revealed that the negative electrode should work at 0.5 V or less, preferably 0.3 V or less with respect to the Li/Li⁺ potential.

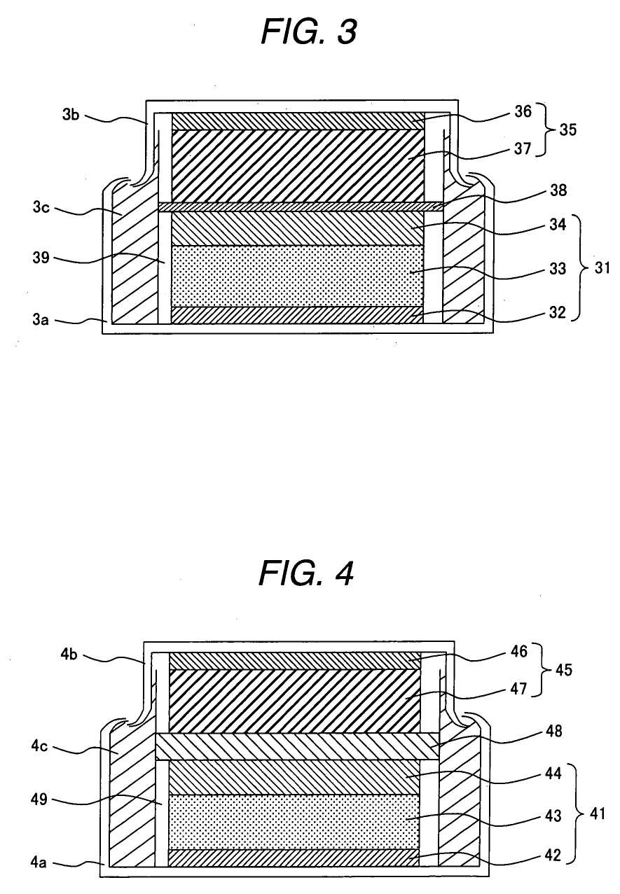

One of the embodiments of the present invention will be explained by reference to FIG. 3, which shows a cross sectional view of a coin type energy storage device of the embodiment of the present invention.

Numeral 31 denotes a positive electrode plate, which is prepared by coating a positive active material layer 33 made of a positive active material capable of inserting and releasing mainly lithium ions on a positive electrode collector 32 and a layer 34 for non-faradic reaction.

Numeral 35 denotes a negative electrode plate, which is prepared by coating a negative active material layer 37 made of carbonaceous material which is a negative active material capable of absorbing or occluding and releasing lithium in the form of ions on the negative collector 36.

An insulating layer 38 for insulating the positive electrode plate and the negative electrode plate and for permeating only lithium ions is sandwiched between the positive electrode plate 31 and the negative electrode plate 35, and they are encased in a case. Then, a liquid electrolyte 39 is charged in the case. A positive case 3a and a negative case 3b are sealed with a gasket 3c, and the gasket electrically insulates them from each other.

When the insulating layer 38 and the electrode plates (positive electrode plate 31 and negative electrode plate 35) are fully filled with the electrolyte 39, electrical insulation between the positive electrode plate 31 and the negative electrode plate 35 is secured, thereby to make it possible to transfer ions between the positive electrode plate and the negative electrode plate.

It is possible to fabricate various types of energy storage devices other than the coin type. In the case of cylindrical types, a group of electrodes is prepared by winding a positive electrode plate, a negative electrode plate and an insulating layer sandwiched between the electrode plates. When the electrode plates are wound double-axially, a group of electrodes of a long circular shape in a cross sectional area is produced. In the case of rectangular types, the positive electrode plate and the negative electrode plate are cut into stripes, and the positive electrode stripe and the negative electrode stripe are stacked alternately; then an insulation layer is inserted between the electrode stripes.

In the following, methods of manufacturing the positive electrode plate and the negative electrode are explained.

The positive active material capable of inserting and releasing lithium ions is oxides containing lithium. For example, there are composite oxides represented by LiNiₓMn_{y}Co_{z} (x+y+z=1) such as LiMn_{1/3}Ni_{1/3}Co_{1/3}O₂, LiMn_{0.4}Ni_{0.4}Co_{0.2}O₂, or composite oxides comprising one or more of transition metals such as Co, Ni, Mn, etc.

Since the positive active materials have high electric resistances in general, addition of carbon powder as an electric conductor compensates electric conductivity of the positive active materials. Since the positive active material and the electric conductor are powders, they are mixed with a binder, coated on the collector and shaped. The electric conductors include natural graphite, synthetic graphite, cokes, carbon black, amorphous carbon, etc.

The positive electrode collectors may be made of materials that do not dissolve in the liquid electrolyte; aluminum foil may be used as the positive electrode collector.

A positive slurry mixture comprising the positive active material, the electric conductor, the binder and the liquid electrolyte is coated on the positive electrode collector with a blade, i.e. by a doctor blade method to prepare a positive active material layer; then the layer is dried by heating to remove solvents. The positive active material layer is shaped by pressurizing with roles.

A layer that brings about non-faradic reaction is coated on the positive active material layer thus prepared. As the layer for non-faradic reaction, there are materials that have a large specific surface area and do not bring about oxidation-reduction reaction over a wide potential range, such as activated charcoal, carbon black, carbon nanotubes, etc.

From the viewpoints of the specific surface area and material cost, activated charcoal is most preferable. More preferably, charcoal having a particle size of 1 to 1000 μm, the specific surface area of 100 to 3000 m²/g, fine pores called micro-pores of 0.002 μm in diameter, fine pores called meso-pores of 0.002 to 0.05 μm and fine pores called macro-pores of 0.05 μm or more may be used. The slurry comprising the activated charcoal and the binder is coated on the positive active material layer to bind the non-faradic reaction layer to the positive electrode.

The thus prepared positive active material layer and the non-faradic reaction layer are heated to dry them by removing the organic solvent. Thereafter, they are role-pressed to firmly bind and contact them each other. The binder used in these steps includes polytetrafluoroethylene, polyvinylidene fluoride, fluorine containing resins such as fluorine rubber, thermoplastic resins such as polypropylene, polyethylene, etc., thermosetting resins such as polyvinyl alcohol, etc.

When activated charcoal is used as the non-faradic reaction layer, the capacity rate C₂/C₁ of the positive active material layer to the activated charcoal layer should preferably be 5% or more. If the rate is less than 5%, it is not expected that an output change with respect to the charge-discharge state is suppressed.

As the negative active materials, graphite or amorphous carbon that is capable of electro-chemically absorbing or occluding and releasing lithium ions may be used; in order to improve the output performance, it is preferable to use amorphous carbon having a (002) face distance measured by an X ray-diffraction method. The amorphous carbon has d₀₀₂=0.350 to 0.390 nm and an average particle size of 1 to 50 μm.

Since negative active materials are powder in general, a binder is mixed with the negative active material and the mixture is coated on the collector; then the coated member is pres-molded. Negative electrode collector materials should be ones that do not alloy with lithium, for example, copper foil.

A negative electrode slurry containing a negative active material, a binder and an organic solvent is coated a doctor blade method, for example, on the negative electrode collector and dried. The coated member is role-pressed to form a negative electrode material.

When the negative collector functions as the energy storage device, it should preferably work at 0.8 V or less, preferably at 0.5 V or less with respect to Li/Li⁺ potential. In order to obtain such the negative electrode plate, a substance that can occlude lithium ions in the negative active material is used. Thus, the negative electrode plate and the lithium metal are contacted in the liquid electrolyte or the negative electrode plate and lithium metal are disposed by way of a separator thereby to insert lithium ions into the electrode plate by charging. When a discharge capacity in a range of from 3.0 to 4.2 V of the positive electrode plate with respect to the Li/Li⁺potential is Cₚ, a discharge capacity in a range of from 0 to 2 V of the negative electrode plate is Cₘₗ and a discharge in a range of from 2.0 to 0.5 V of the negative electrode is Cₘ₂, it is preferable to occlude lithium ions in the negative electrode plate in advance in such a manner that there is the following relationship among Cₚ, Cₘ₁ and Cₘ₂:
Cₚ≦Cₘ₁−Cₘ₂

The insulating layer electrically insulates the positive electrode plate and the negative electrode plate, and is made of a porous polymeric material that penetrates only mobile ions, such as polyethylene, polypropylene, polyethylene tetra fluoride, etc.

Examples of liquid electrolytes are organic solvents such as ethylene carbonate (EC), propylene carbonate (PC), dimethyl carbonate (DMC), diethyl carbonate (DEC), methyl ethyl carbonate (MEC), etc, which contain lithium salt electrolytes such as lithium phosphate hexafluoride (LiPF₆), lithium borate tetra-fluoride (LiBF₄), etc in an amount of 0.5 to 2 M. The liquid electrolytes may contain salts containing quarternary onium cations such as tetra-alkyl phosphonium tetra-fluoroborate, tetra-alkyl ammonium tetra-fluoroborate, etc.

In the energy storage device, the electrolyte contains, in addition to the lithium salt or lithium compound as a source of mobile ions, a quarternary onium cation salt represented by the general formula: 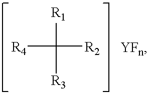
wherein R₁, R₂, R₃ and R₄ are the same or different, and hydrogen or alkyl groups having carbon atoms of 1 to 3, X is N or P, Y is B, P or As and n is an integer of 4 or 6.

As shown in FIG. 4, the energy device according to the present invention can be manufactured by disposing a gel electrolyte 48 between the positive electrode plate 41 and the negative electrode plate 45. The gel electrolyte can be prepared by swelling polymers such as polyethylene oxide (PEO), poly-methyl metacrylate (PMMA), polyacrylonitrile (PAN), polyvinylidene fluoride (PVdF), polyvinylidene-hexafluoro propylene copolymer (PVdF-HFF), etc with liquid electrolytes.

In assemling an energy storage device module comprising a plurality of the energy storage devices, the following method may be employed. A plurality of energy storage devices in accordance with a desired voltage is electrically connected in series. There are disposed means for detecting a voltage of each of the energy storage devices and a control means for controlling charge-discharge current flowing through each of the energy storage devices, and means for giving instructions to the above-mentioned means. Communications are carried out between the above-mentioned means by means of electric signals.

When a voltage of the energy storage devices is detected in charging and it is lower than a predetermined value, current is supplied to the energy storage devices to charge them. When the voltage of the energy storage devices reaches the predetermined voltage, the current is cut in accordance with instructions given by the means for giving the instructions, thereby to prevent overcharging of the energy storage devices.

In discharging, voltages of the energy storage devices are detected by the voltage detecting means; when the voltage reaches the predetermined voltage, discharge current is cut. It is preferable that an accuracy of the voltage detector should depend on a voltage resolution of 0.1 V or less, more preferably, a voltage resolution of 0.02 V or less. According to the accurate detection of the voltage of the energy storage devices and the controlling of the devices, avoiding over charge and over discharge, a desired energy storage device module is realized. The energy storage device module of the present invention has excellent short-time output characteristics at low temperatures.

Next, embodiments of the energy storage devices of the present invention will be explained in detail. The scope of the present invention is not limited by the embodiments, however.

(Embodiment 1)

A coin type energy storage device having a structure shown in FIG. 3 was prepared. A positive electrode active material layer 33 was prepared in the following manner.

As the positive electrode active material, LiCo_{1/3}Ni_{1/3}Mn_{1/3}O₂ having an average particle size of 10 μm was used. As conductive materials, graphite like carbon powder having an average particle size of 3 μm and a specific surface area of 13 m²/g and carbon black having an average particle size of 0.04 μm and a specific surface area of 40 m²/g were used in a weight ratio of 4:1. As a binder, a solution containing polyvinylidene fluoride in a concentration of 8% by weight dissolved in N-methyl pyrrolidone was used. The positive electrode active material, conductive material and binder solution were mixed so as to make a composition of the positive electrode active material: the conductive material: polyvinylidene fluoride=85:10:5; the mixture was thoroughly mixed to prepare a positive electrode slurry.

The positive electrode slurry was coated on one face of a collector 32 made of aluminum foil having a thickness of 20 μm and dried. The coated member was pressed with roles.

Further, an activated charcoal layer 34 was formed on the positive electrode active material layer 33 in the following manner.

Activated charcoal having a specific surface area of 2000 m²/g and carbon black having a specific surface area of 40 m²/g and an average particle size of 0.04 μm were mixed at a weight ratio of 8:1, using as a binder a solution containing 8% by weight of polyvinylidene fluoride dissolved in N-methyl pyrrolidone so that a composition of activated charcoal:carbon black:polyvinylidene fluoride=80:10:10 was prepared. The slurry was coated on the positive electrode active material layer 33. The coated article was dried and pressed with roles to prepare a positive electrode material.

The electrode material was punched out into a disc having a diameter of 16 mm to make a positive electrode plate 31. When the positive electrode plate and a counter electrode made of lithium metal were used, the positive electrode capacity Cₚ was 2.7 mAh at the time of charge-discharge at a potential of 3.0 to 4.3 V with respect to the Li/Li⁺ potential. Further, C₁ and C₂ were 2.4 mA, and 0.2 mA, and C₂/C₁=8.3%, the values being measured at a potential of 3.0 to 4.3 V of the Li/Li⁺ potential of the positive electrode active material layer 33 and the activated charcoal layer 34.

The negative electrode active layer 37 was prepared in the following manner.

As a negative electrode active material, amorphous carbon (d₀₀₂=0.360 nm) having an average particle size of 10 μm and carbon black having an average particle size of 0.04 μm and a specific surface area of 40 m²/g were mechanically mixed in a ratio of 95:5. As a binder, a solution containing 8% by weight of polyvinylidene fluoride dissolved in N-methylpyrrolidone was used. Then, the solution and the mixture of the amorphous carbon and carbon black were thoroughly mixed so as to make a composition of the mixture:polyvinylidene fluoride=90:10.

The resulted slurry was coated on a negative electrode collector 36 made of copper foil having a thickness of 10 μm and dried. The coated member was pressed with roles to make a negative electrode material. The electrode material was punched out into a disc having a diameter of 16 mm to make the negative electrode 35.

The negative electrode and a counter electrode of lithium metal were used to measure Cₘ₁, at the time of charge-discharge at 2.0 to 0 V with respect to the Li/Li⁺potential. The measured Cₘ₁, was 4.6 mAh. Next, a counter electrode is lithium metal in the following manner was used in combination with the negative electrode into which lithium ions were occluded. A constant current of 0.5 mA was supplied until the voltage reaches 0.5 V to occlude lithium ions in an amount equivalent to 1.7 mAh (Cₘ₂) in the negative electrode plate. The Cₘ₁−Cₘ₂ was 2.9 mAh, which was larger than Cₚ. When the separator was sandwiched between the negative electrode plate and the counter electrode of lithium metal, a potential of the negative electrode plate with respect to the Li/Li⁺potential was 0.5 V or less when a charge-discharge voltage between the positive and negative electrode was 2.7 to 4.2 V.

A porous polyethylene separator 38 having a thickness of 40 μm was sandwiched between the positive and negative electrode and a mixed liquid electrolyte 39 consisting of ethylene carbonate and diethyl carbonate (a volume ratio; 1:1) containing 1 mol/dm³ of LiPF₆ was charged. The positive can 3a and negative can 3b were sealed with a gasket 3c to electrically insulate them.

(Embodiment 2)

In the positive electrode plate of embodiment 1, a coin type energy storage device was manufactured in the same way as in embodiment 1, except that a positive electrode, which has a reduced coating amount of activated charcoal was used so that capacities C₁, C₂ were 2.4 mAh, 0.15 mAh, respectively, and C₂/C₁ became 6.3%. The capacity Cₚ of the positive electrode plate was 2.5 mAh. Cₘ₁−Cₘ₂ at the negative electrode was 2.9 mAh, which is larger than Cₚ. The separator was sandwiched between the positive and negative electrodes and a counter electrode of lithium metal as a reference electrode was used to charge and discharge at a voltage between the electrodes of 2.7 to 4.2 V. The potential of the negative electrode plate with respect to the Li/Li⁺ potential was 0.5 V or less.

### COMPARATIVE EXAMPLE 1

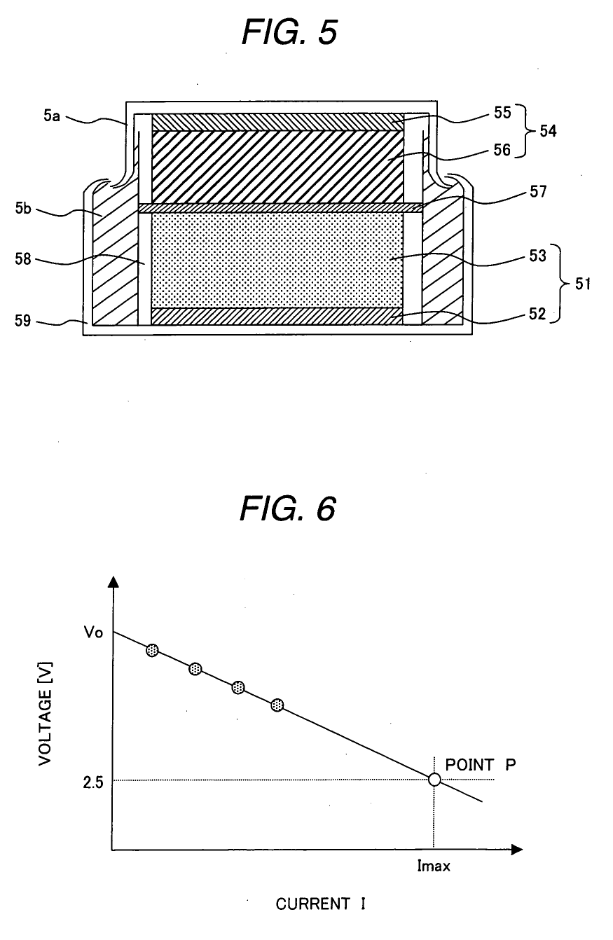

A coin type lithium secondary battery having a structure shown in FIG. 5 was manufactured. A positive active material layer 53 was prepared in the following manner.

A positive active material was LiCo_{1/3}Ni_{1/3}Mn_{1/3}O₂ having an average particle size of 10 μm, and a conductive material was a mixture of graphite like carbon powder having an average particle size of 3 μm and a specific surface area of 13 m²/g and carbon black having an average particle size of 0.04 μm and a specific surface area of 40 m²/g in a weight ratio of 4 to 1 was used. As a binder, polyvinylidene fluoride was dissolved in N-methyl pyrrolidone to obtain a solution of a concentration 8% by weight of polyvinylidene fluoride. The positive active material, conductive material and polyvinylidene fluoride were thoroughly mixed in a ratio of 85:10:5 to obtain a positive electrode slurry.

The positive electrode slurry was coated on one face of a positive electrode collector 52 made of aluminum foil having a thickness of 20 μm, and dried. The coated member was pressed with roles to obtain an electrode material. The electrode material was punched into a disc having a diameter of 16 mm to obtain an electrode 51.

Using the positive electrode and a counter electrode of lithium metal, a capacity at the time of charge-discharge at 3.0 to 4.3 V with respect to the Li/Li⁺ potential was measured. The capacity was 2.4 mAh.

Then, a negative electrode active material layer 56 was prepared in the following manner.

Amorphous carbon (d₀₀₂=0.360 nm) having an average particle size of 10 μm and carbon black having an average particle size of 0.04 μm and a specific surface area of 40 m²/g were mechanically mixed in a weight ratio of 95 to 5.

A binder was an N-methylpyrrolidone solution containing polyvinylidene fluoride in an amount of 8% by weight. The carbonaceous mixture of the activated charcoal and the carbon black was thoroughly mixed with the solution in a weight ratio of 90 to 10.

The resulting slurry was coated on one face of a negative electrode collector 55 made of copper foil having a thickness of 10 μm and dried. The coated member was pressed with roles to manufacture an electrode material. The electrode material was punched into a disc having a diameter of 16 mm to obtain a negative electrode 54.

Using a lithium metal as a counter electrode, a charge-discharge capacity at 2.0 to 0 V with respect to the Li/Li⁺ potential was measured. The capacity was 3.0 mAh.

A polyethylene porous separator 57 having a thickness of 40 μm was sandwiched between the positive electrode and negative electrode, and a liquid mixed electrolyte solution 58 of polycarbonate and dimethyl carbonate in a volume ratio of 1 to 1 and 1 mole/dm³ of LiPF₆ containing was charged. The positive can 59 and negative can 5a were sealed with gasket 5b and electrically insulated from each other.

### COMPARATIVE EXAMPLE 2

A coin type energy storage device of a structure shown in FIG. 3 was manufactured in the same manner as in comparative example 1, except that the positive electrode plate of the embodiment 1 was used.

Using the positive electrode and a counter electrode of lithium metal, the positive capacity Cₚ at the time of a charge-discharge at 3.0 to 4.3 V with respect to the Li/Li⁺ potential was measured. Cₚ was 2.7 mAh.

Capacities C₁, C₂ measured in a range of 3.0 to 4.3 V with respect to the Li/Li⁺ potential of the positive electrode active material layer 33 and the activated charcoal layer 34 were 2.4 mAh and 0.2 mAh, respectively, and C₂/C₁ was 8.3%.

Using the negative electrode and a counter electrode of lithium metal, capacity of charge-discharge conducted at 2.0 to 0 V with respect to the Li/Li⁺ potential was 3.3 mAh.

### COMPARATIVE EXAMPLE 3

A coin type energy storage device of a structure shown in FIG. 1 was manufactured in the same manner as in comparative example 1, except that the negative electrode of embodiment 1 was used. The positive electrode capacity Cₚ at 3.0 to 4.3 V with respect to the Li/Li⁺ potential was 2.4 mAh, and the negative electrode capacity Cₘ₁ at 2.0 to 0 V was 4.6 mAh.

Next, lithium ions were occluded into the negative electrode plate in the following manner in advance. Using the counter electrode of lithium metal, charging was conducted at a constant current of 0.5 mA until 0.5 V so that lithium ions equivalent to 1.7 mAh (Cₘ₂) were occluded into the negative electrode plate. (Cₘ₁−Cₘ₂) was 2.9 mAh, which was larger than the value of Cₚ.

A separator was sandwiched between the positive and negative electrodes and a reference electrode of lithium metal were used to conduct charge-discharge at 2.7 to 4.2 V between the electrodes. The voltage of the negative electrode with respect to the Li/Li⁺ potential was 0.5 V or less.

### COMPARATIVE EXAMPLE 4

A coin type energy storage device was manufactured in the same manner as in embodiment 1, except that a positive electrode whose coating amount of the activated charcoal was reduced was used so that the capacities C₁, C₂ of the positive electrode plate in embodiment 1 were 2.4 mAh and 0.09 mAh, respectively, and C₂/C₁ was 3.8%. The capacity Cₚ of the positive electrode plate was 2.4 mAh. (Cₘ₁−Cₘ₂) of the negative electrode was 2.9 mAh, which was larger than the value of Cₚ.

A separator was sandwiched between the electrodes and a reference electrode of lithium metal was combined with the electrodes. When charge-discharge was conducted at a voltage between the electrodes of 2.7 to 4.2 V, the potential of the negative electrode was 0.5 V or less with respect to the Li/Li⁺ potential.

Using the energy storage devices of embodiments 1, 2 and of comparative examples 2,4 and the lithium secondary batteries of comparative examples 1,3, output characteristics at 25° C. and −30° C. were evaluated in the following manner.

(A Method of Evaluating Output Characteristics)

The above-mentioned energy storage devices and secondary batteries were subjected to discharge tests at 25° C. After charging at a constant current of 0.5 mA/cm² until 4.2 V, a constant current-voltage charging was conducted at 4.2 V for three hours. After the charging was completed, followed by an standstill time for 30 minutes, a constant current discharge was conducted at 0.25 mA/cm² until the discharge voltage of 2.7 V. The discharge was repeated 5 times.

Then, after charging at a constant current of 0.5 mA/cm², the constant current-voltage charging at 4.2 V was conducted for 3 hours. DOD (Depth of Discharge) of the state of charging until 4.2 V is defined as 0%. After an standstill of 30 minutes, short time discharges were conducted at 2.5 mA/cm², 5 mA/cm², 10 mA/cm², 15 mA/cm² and 20 mA/cm² for 10 seconds for each discharge to evaluate output characteristics. DOD is defined as a rate (%) of discharge capacity to a rated capacity of a battery. The rated capacity is the discharge capacity in the range of from 4.2 V to 2.7 V; the discharge capacity rate at 4.2 V is 0% and the discharge capacity sate at 2.7 V is 100%.

A standstill of 10 minutes was conducted after each of the discharges; then charges were conducted after the standstill to compensate the capacity discharged at each of the discharges at a current density of 0.25 mA/cm². For example, charge after discharge at 2.5 mA/cm² for 10 seconds is conducted 0.25 mA/cm² for 100 seconds. After the above-mentioned charge, a standstill of 30 minutes was employed to wait that the voltage becomes stabilized for the next test.

Then, capacity equivalent to DOD=10% was discharged at a constant current of 0.25 mA/cm². Thereafter, the output characteristics were investigated under the condition of DOD=−0%. A voltage at 5 seconds after the start of discharge was read out from a charge-discharge curve obtained by the 10 seconds discharge tests.

Current values and voltages were plotted in the coordinate of the abscissa being current value at the time of measurement and the ordinate being a voltage at 5 seconds after the start of measurement. The crossing point P that crosses at 2.5 V, as shown in FIG. 6, was obtained by interpolating a straight line obtained by the least squares method from a V-I characteristic curve. The output density was calculated as:
(A current value of the interpolated cross point P) ×(voltages V₀ at the start of discharges)/(weight amounts of material composition of the positive and negative electrodes)

Measurement at −30° C. was conducted under the following conditions.

Each of the energy storage devices and lithium secondary batteries was charged at a constant current density of 0.5 mA/cm² until 4.2 V at 25° C.; thereafter, a constant current-voltage charge at a constant voltage of 4.1 V was conducted for three hours. After the charge was completed, standstill of 30 minutes was conducted. Then, a discharge at a constant current of 0.25 mA/cm² was conducted until DOD=50%. Ambient temperature was kept at −30° C. After lapse of 5 hours, short time discharges at current values of 0.05 mA/cm², 1.5 mA/cm² and 3.0 mA/cm² for 10 seconds were conducted to investigate output characteristics. The output characteristics were calculated in the same method at 25° C.

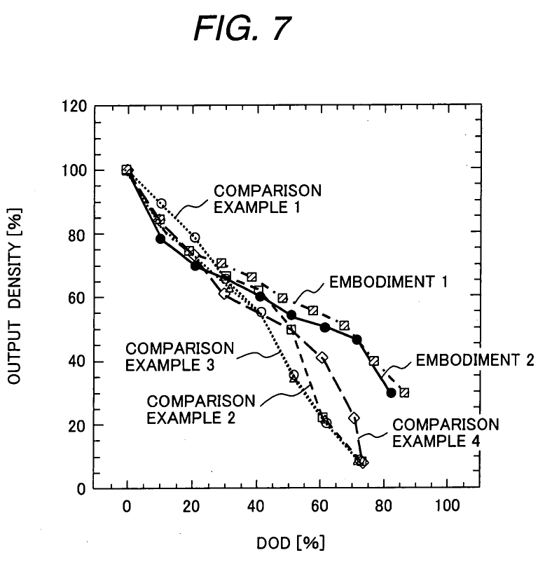

Relationship between DOD at 25° C. and an output density for output characteristics is shown in FIG. 7, wherein the value at DOD=0% is defined as 1 on the abscissa. The device and batteries of comparative examples 1 to 4 do not generate power at DOD of 80% or more, while the devices of embodiments 1 and 2 exhibit little change of output with respect to DOD over the wide range and generate output even at DOD of 80% or more.

Evaluation results at −30° C. are shown as relative values in Table 1, wherein the output of the battery of the comparative example 1 is defined as 1.

TABLE 1

| | C₂/C₁ (%) | Output ratio |
|---|---|---|
| Embodiment 1 | 8.3 | 3.7 |
| Embodiment 2 | 6.3 | 3.2 |
| Comparative example 1 | 0 | 1.0 |
| Comparative example 2 | 8.3 | 2.3 |
| Comparative example 3 | 0 | 0.9 |
| Comparative example 4 | 3.8 | 1.8 |

As is apparent from Table 1, output characteristics of the devices and batteries of comparative examples 2, 3 and embodiments 1, 2 are better than those of comparative example 1; the larger the capacity ratio C₂/C₁ of the positive electrode active material layer, the larger the output ratio becomes.

From the above facts, it is possible to lower the change of output density in the charge-discharge state or with respect to DOD, and to remarkably improve output characteristics at low temperatures.

Pulse cycle characteristics of the energy storage devices of embodiments 1, 2, comparative examples 2, 4 and the lithium secondary batteries of comparative examples 1, 3 were evaluated at 25° C. in accordance with the following manner.

(An Evaluation Method of Pulse Cycle Characteristics)

The energy storage devices and lithium secondary batteries were charged at 25° C. in accordance with the following conditions.

At first, after the devices or batteries were charged at a constant current density of 0.5 mA/cm² until 4.2V, the constant current-voltage charge was conducted at 4.2 V for three hours. After the charge was completed, followed by standstill of 30 minutes, discharge was conducted at a constant current of 0.25 mA/cm² until the termination voltage of 2.7 V. This discharge was repeated 5 times. Then, the devices, etc were charged at a constant current of 0.5 mA/cm² until 3.6 V.

Thereafter, pulse cycle tests were conducted, wherein discharge and charge at 15 mA/cm² for 10 seconds were repeated. One pulse cycle consists of discharge of 10 seconds plus charge of 10 seconds (20 seconds in total in one cycle). Discharge at a constant current of 0.25 mA/cm² conducted until the discharge termination voltage of 2.7 V after the pulse cycles of 2000, and then capacity was evaluated.

After charging at the constant current of 0.5 mA/cm², the constant current-voltage charging at a constant voltage of 4.2 V was conducted for 3 hours. After the charging was completed, followed by standstill of 30 minutes, a constant current discharge at 0.25 mA/cm² was conducted until the discharge termination of 2.7 V. The discharge capacity at this discharge was a capacity for evaluation of the capacity. The discharge capacities after the pulse cycles of 2000 times are shown in Table 2 as rates to the discharge capacity before the pulse cycle test, i.e. capacity keeping rates. The capacity keeping rate is defined as a rate (%) of a discharge capacity after the pulse cycle test to a discharge before the pulse cycle test.

TABLE 2

| | Rate (%) of capacity after cycle test |
|---|---|
| | to capacity before cycle test |
| Embodiment 1 | 85 |
| Embodiment 2 | 78 |
| Comparative example 1 | 46 |
| Comparative example 2 | 69 |
| Comparative example 3 | 48 |
| Comparative example 4 | 61 |

From Table 2, the energy storage devices of the embodiments 1 and 2 exhibit excellent rates of capacity keeping.

(Embodiment 3)

A coin type energy storage device was manufactured, using the positive electrode active material LiMn_{0.4}Ni_{0.4}Co_{0.2}O₂ of the positive electrode active material layer in Embodiment 1 wherein the active material has an average particle size of 10 μm. A conductive material was a mixture of graphite like carbon having an average particle size of 3 μm and a specific surface area of 13 m²/g and carbon black having an average particle size of 0.04 μm and a specific surface area of 40 m²/g in a weight ratio of 4 to 1.

As a binder, an N-methyl pyrrolidone solution containing 8% by weight of polyvinylidene fluoride was thoroughly mixed with the positive electrode active material and conductive material so that a slurry of a mixing ratio of the positive electrode active material, conductive material and polyvinylidene being 85:10:5 was obtained.

The positive electrode slurry was coated on one face of the positive electrode collector made of aluminum foil having a thickness of 20 μm and dried. The coated member was pressed with roles.

An activated charcoal layer was formed on the above positive electrode active material layer. Activated charcoal having a specific surface area of 2000 m²/g and carbon black having an average particle size of 0.04 μm and a specific surface area of 40 m²/g were mixed in a weight ration of 8:1. As a binder, an N-methyl pyrrolidone solution containing 8% by weight of polyvinylidene fluoride was thoroughly mixed to make a composition of the activated charcoal:carbon black:polyvinylidene being 80:10:10.

The resulting slurry was coated on the positive electrode active material layer and dried. The coated member was pressed with roles to prepare electrode material. The electrode material was punched into a disc having a diameter of 16 mm to obtain a positive electrode plate.

Capacities C₁, C₂ measured in a range of from 3.0 to 4.3 V with respect to the Li/Li⁺ potential of the positive electrode active material and the activated charcoal layer that constitute the positive electrode plate were 2.3 mAh and 0.2 mAh, respectively, and C₂/C₁ was 8.7%.

Next, a negative electrode active material was prepared in the following manner.

As a negative electrode active material, a mixture of amorphous carbon (d₀₀₂=0.360 nm) having an average particle size of 10 μm and carbon black having an average particle size of 0.04 μm and a specific surface area of 40 m²/g in a weight ratio of 95:5 was prepared. As a binder, the N-methylpyrrolidone solution containing 8% by weight of polyvinylidene fluoride was mixed with the carbonaceous material. A weight ratio of the carbonaceous material to polyvinylidene fluoride was 90:10.

The resulting slurry was coated on one face of the negative electrode collector made of copper foil having a thickness of 10 μm and dried. The coated member was pressed with roles. The electrode material was punched into a disc having a diameter of 16 mm to make a negative electrode. The negative electrode capacity Cₘ₁ with respect to the Li/Li⁺ potential was 4.6 mAh.

Next, lithium ions were previously occluded into the negative electrode plate in the following manner.

Using a counter electrode of lithium metal, the negative electrode was subjected to charge at a constant current of 0.5 mA until 0.5 V to occlude lithium ions in an amount equivalent to 1.7 mAh (Cₘ₂).

A polyethylene porous separator was sandwiched between the positive and negative electrodes, and a mixed electrolyte liquid consisting of ethylene carbonate and dimethyl carbonate in a volume ratio of 1 to 1 and containing 1 mol/dm³ of LiPF₆ was charged. The positive electrode can and the negative electrode can were sealed and electrically insulated with a gasket.

(Embodiment 4)

A coin type energy storage device was manufactured using LiNi_{0.8}Co_{0.15}Al_{0.05}O₂ as a positive electrode active material of the positive electrode active material layer having an average particle size of 6 μm.

A positive electrode active material was prepared. A conductive material consists of graphite like carbon having an average particle size of 3 μm and a specific surface area of 13 m²/g and carbon black having an average particle size of 0.04 μm and a specific surface area of 40 m²/g in a weight ratio of 4 to 1.

As a binder, an N-methyl pyrrolidone solution containing 8% by weight of polyvinylidene fluoride was mixed with the positive electrode active material and the conductive material in a weight ratio of the positive active material:the conductive material:polyvinylidene fluoride was 85:10:5.

The resulting slurry was coated on one face of the positive electrode of aluminum foil having a thickness of 20 μm and dried. The coated member was pressed with roles.

An activated charcoal layer was formed on the positive electrode active material layer in the following manner.

Activated charcoal having a specific surface area of 2000 m²/g and carbon black having an average particle size of 0.04 μm and a specific surface area of 40 m²/g were thoroughly mixed in a weight ratio of 8 to 1. As a binder, an N-methyl pyrrolidone solution containing 8% by weight of polyvinylidene fluoride was mixed with the activated charcoal and carbon black in a weight ratio of activated charcoal:carbon black:polyvinylidene fluoride=80:10:10. The resulting slurry was coated on the positive electrode active material layer and dried. The coated member was pressed with roles to obtain an electrode material.

The electrode material was punched into a disc having a diameter of 16 mm to obtain a positive electrode. The capacities C₁, C₂ measured in a range of from 3.0 to 4.3 V with respect to the Li/Li⁺ potential were 3.3 mAh and 0.2 mAh, respectively, and C₂/C₁ was 6.0%.

A negative electrode active material was prepared in the following manner.

As negative electrode active material, amorphous carbon (d₀₀₂=0.360 nm) having an average particle size of 10 μm and carbon black having an average particle size of 0.04 μm and a specific surface area of 40 m²/g were mechanically mixed at a mixing ratio of 95:5.

As a binder, an N-methylpyrrolidone solution containing 8% by weight of polyvinylidene fluoride was mixed with the carbonaceous material in a weight ratio of carbonaceous material:polyvinylidene fluoride=90:10.

The resulting slurry was coated on one face of the negative electrode collector made of copper foil having a thickness of 10 μm and dried. The coated member was pressed with roles. The resulting electrode material was punched into a disc having a diameter of 16 mm. The negative electrode capacity Cₘ₁ with respect to the Li/Li⁺ potential was 5.4 mAh.

Next, lithium ions were doped in the negative electrode in the following manner.

Using a lithium electrode as a counter electrode, charging at a constant current of 0.5 mA was conducted until 0.5 V, thereby to occlude lithium ions in an amount equivalent to 1.9 mAh (Cₘ₂) in the negative electrode. The positive can and the negative can were sealed with gasket and they are electrically insulated from each other.

A polyethylene porous separator was sandwiched between the positive electrode and the negative electrode, and a mixed electrolyte of ethylene carbonate (a volume ratio=1:1) and dimethyl carbonate and containing 1 mol/dm³ of LiPF₆ was charged. The positive can and the negative can were sealed with gasket and electrically insulated from each other.

(Embodiment 5)

In the coin type energy storage device in embodiment 1, a mixed solvent consisting of ethylene carbonate and dimethyl carbonate (volume ratio; 1:1) containing 1 mol/dm³ of LiPF₆ and 0.05 mol/dm³ of (C₂H₅)₄NBF₄ was used in place of the mixed solvent containing 1 mol/dm³ of LiPF₆.

(Embodiment 6)

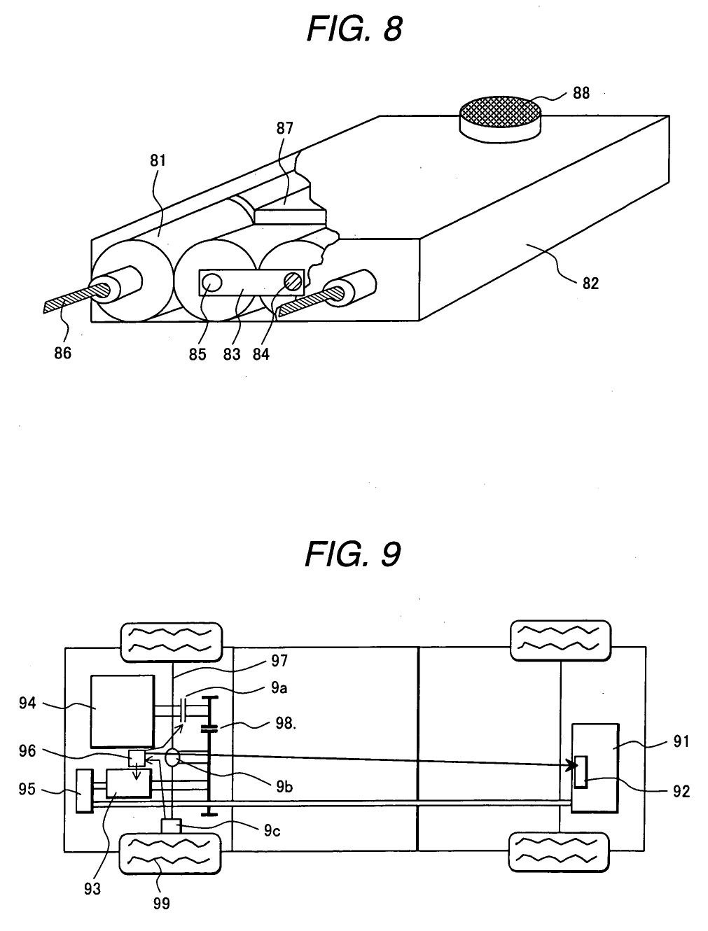

An energy storage device module shown in FIG. 8 was assembled using a plurality of energy storage devices 81. 24 Of energy storage devices were electrically connected in series. They were encased in a rectangular resin case 52. A copper plate 83 of 2 mm thick made a connection between the energy storage devices 81. The copper plates 83 were screwed to a positive electrode terminal 84 and a negative electrode terminal 85 of the energy storage devices.

Charge-discharge current flows into and flows out from the energy storage device module through a cable 86. The energy storage devices 81 are connected to a control circuit 87 through a signal line thereby to monitor a voltage and a temperature of the devices during charge-discharge of the devices. The module is provided with a cooling conduit 88.

(Embodiment 7)

A hybrid car was assembled, using two energy storage device modules. A diagrammatic view of the hybrid car is shown in FIG. 9. Numeral 91 denotes the energy storage device module, 92 a module control circuit, 93 a motor for driving, 94 an internal combustion engine, 95 an inverter, 96 a power control circuit, 97 a driving shaft, 9a a crutch, 9b a gear and 9c a speed monitor.

At the time of starting the car, power output from the energy storage device module 91 is converted into alternative power, which is supplied to the driving motor 93 to drive it. The motor drives the driving wheel 99 to move the car.

In accordance with signals from the power control circuit 96, the module control circuit 92 supplies power from the energy storage device module 91 to the driving motor 93. When the running speed by the driving motor exceeds 20 km/h, the power control circuit 96 issues signals to connect the clutch 9a so that the engine 94 is brought into cranking by rotating energy of the driving wheel 99.

The power control circuit 96 judges in accordance with signals from the speed monitor 9c and the stepping condition of accelerator to adjust power supply to the driving motor 93, thereby to control the rotating speed of the engine 94. At the time of deceleration, the driving motor 93 functions as a generator to regenerate power to the energy storage device module 91. The hybrid car that is equipped with the energy storage device module of the present invention has improved short time output characteristics at low temperatures and improved short time performance of the driving motor at low temperatures.

The energy storage devices or energy storage device modules of the present invention may be applied to various fields. Examples are power sources for portable information terminals such as personal computers, word processors, codeless handsets, electronic books, players, portable telephones, car telephones, pocket bells, handy terminals, transceivers, wireless radios.

The devices or modules may be used for power sources of portable appliances such as portable coping machines, electronic notebooks, portable calculators, liquid crystal TV sets, portable radios, tape-recorders, headphone stereos, portable CD players, video movies, electric shavers, electronic translators, voice input devices, memory cards, etc.

Further, the devices or modules may be applied to home electric appliances such as refrigerators, air-conditioners, TV sets, stereos, water warmers, microwave ovens, dish-washers, dryers, washing machines, lighting apparatus, toys, etc.

As an industry use or general use, the devices or modules may be applied to medical apparatus, power storage systems, elevators, etc.

Advantages of the devices or modules are remarkable in appliances or systems that need high output-input, such as power sources for mobiles including electric cars, hybrid cars, golf carts, etc.

1. An energy storage device comprising a positive active material layer having a positive active material capable of inserting and releasing lithium ions, a positive electrode plate having a layer capable of effecting non-faradic like reaction upon physical adsorption and desorption of the ions to accumulate and discharge charges, and a negative plate having a negative active material layer made of carbonaceous material that is capable of absorbing and releasing mainly lithium in the ionized state in a collector, and an insulator layer for electrically insulating the positive electrode plate from the negative electrode plate that is capable of permeating only mobile ions.

2. The energy storage device according to claim 1, wherein a working potential of the negative electrode plate is 0.5 V or less with respect to a Li/Li⁺ potential, when the device is used within a range of 2.7 V to 4.2 V.

3. The energy storage device according to claim 1, wherein the layer where the non-faradic like reaction for accumulating and releasing charges upon adsorption and desorption of the ions takes place has activated charcoal.

4. The energy storage device according to claim 2, wherein a capacitive rate C₂/C₁ of a discharge capacity C₂ of the layer having the activated charcoal measured at a range of from 3.0 to 4.3 V with respect to the Li/Li⁺ potential to a discharge capacity C₁ of the positive active material layer measured in a range of from 3.0 to 4.3 V with respect to the Li/Li⁺potential is 0.05 to 0.2.

5. The energy storage device according to claim 1, wherein a discharge capacity with respect to a Li/Li⁺ potential is Cₚ in a range of from 3.0 to 4.2 V of the potential of the positive electrode, a discharge potential in a range of from 2.0 to 0 V with respect to the Li/Li⁺ potential is Cₘ₁, and a discharge potential in a range of from 2.0 to 0.5 V of the negative electrode is Cₘ₂, lithium is absorbed or occluded in the negative active material in the ionized state in advance by charging in such a manner that there is a relationship among Cₚ, Cₘ₁ and Cₘ₂ as expressed by Cₚ≦Cₘ₁−Cₘ₂.

6. The energy storage device according to claim 1, wherein the positive active material is a member selected from the group consisting of LiNiₓMn_{y}Co_{z}O₂ (x+y+z=1) and composite oxides of Li and one or more of transition metals such as Co, Ni, Mn, etc., and the negative active material is amorphous carbon that has a face distance d₀₀₂=0.350 to 0.390 nm of (002) face measured by an X-ray diffraction method and has an average particle size of 1 to 50 μm.

7. The energy storage device according to claim 1, wherein a gel like electrolyte is disposed between the positive electrode and the negative electrode.

8. The energy storage device according to claim 1, wherein the electrolyte contains, in addition to the lithium salt or lithium compound as a source of mobile ions, a quarternary onium cation salt represented by the general formula: 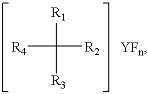
wherein R₁, R₂, R₃ and R₄ are the same or different, and hydrogen or alkyl groups having carbon atoms of 1 to 3, X is N or P, Y is B, P or As and n is an integer of 4 or 6.

9. The energy storage device module comprising a plurality of the energy storage devices according to claim 1, connected in series or in parallel, and a control circuit for controlling the energy storage devices.

10. An electric car driven by the energy storage device module according to claim 8.

11. An energy storage device comprising a positive electrode plate having a positive active material layer capable of inserting and releasing lithium ions and activated charcoal layer, a negative electrode plate having a negative active material layer containing a negative active material made of carbonaceous material that is capable of occluding and releasing lithium ions in a collector, and an insulating layer sandwiched between the positive electrode plate and the negative electrode plate for electrically insulating them from each other and for permeating only the mobile ions, wherein when the energy storage device is used in a range of from 2.7 to 4.2 V, a working potential of the negative electrode is 0.5 V or less with respect to the Li/Li⁺ potential.
